(19) United States
(12) Patent Application Publication
(10) Pub. No.: US 2012/0280580 A1
(43) Pub. Date: Nov. 8, 2012

(54) COOLED FRACTIONAL-HORSEPOWER MOTOR

(75) Inventors: Yung Kang Tso, Shanghai (CN); Guang Long Chen, Shanghai (CN)

(73) Assignee: Aurora Office Equipment Co., Ltd. Shanghai, Shanghai (CN)

(21) Appl. No.: 13/101,010

(22) Filed: May 4, 2011

(51) Int. Cl. H02K 9/02; F28D 15/02; G05D 23/00; F28F 7/00; F28D 15/00

(52) U.S. Cl. 310/48; 165/185; 165/104.34; 165/287; 165/104.21; 310/64

(57) ABSTRACT

Cooling apparatus and methods for a fractional-horsepower motor. Motor cooling apparatus includes a heat shoe, a heat diffuser, and a heat pipe coupled therebetween. The heat shoe is configured to partially cover a portion of, and to receive motor thermal energy from, the motor. The heat pipe is coupled to the heat shoe, and is configured to convey the motor thermal energy from the heat shoe. Heat diffuser can be coupled to receive motor thermal energy from the heat pipe. It is configured to diffuse at least a portion of the motor thermal energy into an ambient atmosphere. A thermal sensor is coupled to the motor and configured to sense a motor thermal condition; and a fan can be coupled to the thermal sensor through a controller. The controller is configured to control the speed of the fan relative to the motor thermal condition sensed by the thermal sensor.

### BACKGROUND

1. Field of the Invention

The present invention relates to electric motors and more particularly to electric motors having cooling apparatus.

2. Background Art

Consumer product satisfaction is driven at a particular product price point by product safety, product reliability, and product longevity. This is particularly so in the field of consumer paper shredders, where a shredder can endure excessive or rough wear despite the non-industrial focus of the shredder product specifications. Such excessive or rough wear can, over time, degrade the reliability and longevity of the shredder product causing the consumer to become dissatisfied with the product. In some cases, repeated stresses on the moving parts of the shredder may cause part failure, leading to the expense of product repair or replacement, a further decrease in satisfaction, or even loss of goodwill for the respective consumer in the paper shredder brand. Even marginally stressful moments of operation may in the aggregate take their toll on the operating machinery of the shredder.

One shredder part which can be vulnerable to mechanical and thermal stresses is the shredder electric motor, which can arise from, for example, frequent starting, overloading, jamming, and continuous, beyond-rating use. Over time, the cumulative stresses faced by a shredder motor may lead to premature failure or poor performance. A common thread with these stressors is the heating effects of motor current (I²R losses). Many sophisticated electronic controllers have been devised to reduce the effects of I²R losses upon motors. Complex mechanical cooling systems have been advanced for large motors, as well. However, in the sphere of fractional-horsepower electric motors, as used in light- to medium-duty paper shredders, sophisticated electronic controllers and complex mechanical coolers can add prohibitive premiums to the motor cost, and to the cost to consumers, reducing a manufacturer's market share. An inexpensive cooling apparatus for fractional-horsepower motors is needed.

### SUMMARY

The foregoing need is met by cooling apparatus and methods for a fractional-horsepower motor. In one embodiment, the motor cooling apparatus includes a heat shoe, a heat diffuser, and a heat pipe coupled therebetween. The heat shoe can be configured to at least partially cover a portion of, and to receive motor thermal energy from, the motor. The heat pipe can be coupled to the heat shoe, and can be configured to convey the motor thermal energy from the heat shoe. The heat diffuser can be coupled to receive motor thermal energy from the heat pipe. It also can be configured to diffuse at least a portion of the motor thermal energy into an ambient atmosphere apart from the motor. In an embodiment, a thermal sensor can be coupled to the motor and configured to sense a motor thermal condition; and a fan can be coupled to the thermal sensor through a controller. The controller is configured to control the speed of the fan relative to the motor thermal condition sensed by the thermal sensor. In another embodiment, the controller is configured to control the speed of the fan relative to motor thermal condition or a motor condition other than the motor thermal condition. In another embodiment, the cooling apparatus is a heat shoe thermally integrated with the heat diffuser.

The method can include conductively receiving motor thermal energy from portion of a fractional-horsepower motor by a heat shoe; conductively receiving motor thermal energy by a heat pipe coupled to the heat shoe; conveying motor thermal energy by the heat pipe to a heat diffuser; receiving motor thermal energy by the heat diffuser from the heat pipe; and releasing the motor thermal energy from the heat diffuser causing the motor to be cooled.

### BRIEF DESCRIPTION OF THE DRAWINGS

Embodiments of the present invention disclosed herein are illustrated by way of example, and are not limited by the accompanying figures, in which like references indicate similar elements, and in which:

FIG. 1 is a graphical illustration of an embodiment of a fractional-horsepower electrical motor cooler, a passive cooler, in accordance with the teachings of the present invention;

FIG. 2 is a graphical illustration of another embodiment of a fractional-horsepower electrical motor cooler, an active cooler, in accordance with the teachings of the present invention;

FIG. 3 is a box illustration of a controller and sensor mechanism which may be used in conjunction with the embodiment of FIG. 2, in accordance with the teachings of the present invention; and

FIG. 4 is a graphical illustration of yet another embodiment of a fractional-horsepower electrical motor cooler, an active cooler, in accordance with the teachings of the present invention.

Skilled artisans can appreciate that elements in the figures are illustrated for simplicity and clarity and have not necessarily been drawn to scale. For example, the dimensions of some of the elements in the figures may be exaggerated relative to other elements to help improve the understanding of the embodiments of the present invention. In the figures, like numbers correspond to like elements.

### DETAILED DESCRIPTION

Embodiments of the present invention can assist in reducing overheating in a motor. In particular, selected embodiments can be used with a fractional horsepower (FHP) motor, as may be used without limitation, to power a home or office paper shredder. Some embodiments are passive devices, while some are active.

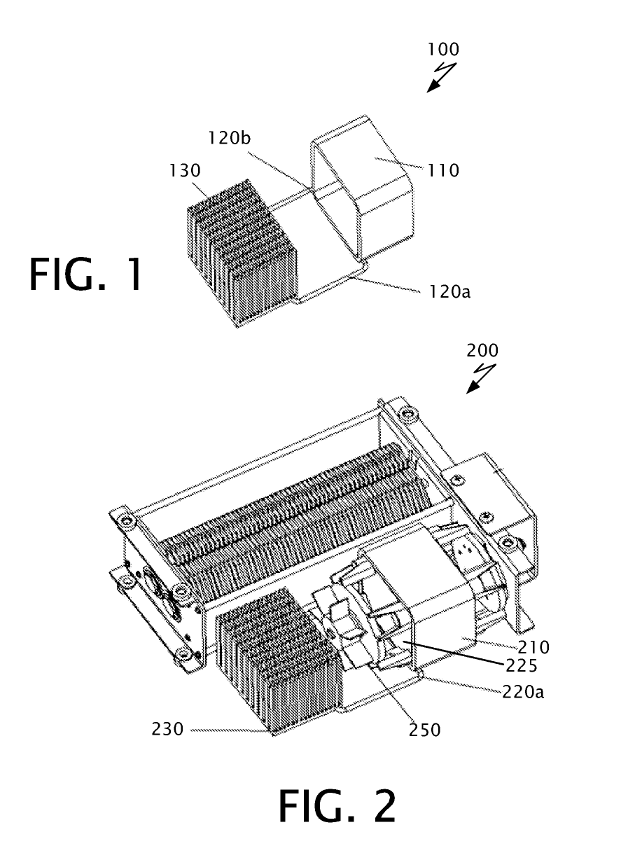

FIG. 1 illustrates an example of passive motor cooler 100, including heat shoe 110 fitted around, and thermally coupled to, the FHP motor (not shown), at least one heat pipe 120a, 120b thermally coupled to the heat shoe, and a heat diffuser 130 thermally coupled to the at least one heat pipe, forming a thermal cooling circuit. Elements including shoe 110 may be joined by thermally conductive adhesives, know to those of ordinary skill in the thermal engineering art. Moreover, a thermally-conductive, electrically-insulative layer may be interposed between the motor and the heat shoe to prevent electrical current from being conveyed by the thermal cooling elements.

Heat shoe 110 can be a device typically formed from conductive material in a manner that contacts at least a portion of a FHP motor casing (not shown). In some embodiments, a heat shoe can be formed to contactingly surround an outer casing of an FHP. A thermally conductive adhesive may be interposed between the FHP casing and heat shoe 110 to improve thermal conduction from the motor into the heat shoe. The heat shoe 110 can be thermally coupled to an end of at least one heat pipe 120a, 120b.

Additional cooling may be achieved on the way to, and at, the cool end, by thermally coupling the thermoconductor 120a, 120b to a radiative heat diffuser 130, or heat sink, such as pin diffuser 130. A pin diffuser may be formed from numerous slim, densely populated radiative fins, often formed on a solid, radiative, heat-spreading metal base. The plural fins assist with radiative, convective, and conductive cooling by the diffuser. In selected embodiments, thermoconductor 120a, 120b may be heat pipes 120a, 120b. A heat pipe, such as heat pipes 120a, 120b, is a passive, highly conductive two-phase heat transfer device, which absorbs heat on one end (“heated end”) and releases heat on the other end (“cooled end”). In this case, the “heated end” is thermally coupled to the FHP motor.

A heat pipe can be characterized by a vacuum tight, sealed containment shell or vessel, a working fluid or coolant, and a capillary wick structure in contact with the containment shell. In general, a coolant in the heat pipe changes from a liquid phase in the cool end to a vapor phase in the heated end. The coolant vapor is drawn back through the wick via capillary action to the cool end, dissipating heat along the way. At the cool end, the coolant returns to a liquid phase, returning again to the heated end to continue the cycle. Heat pipes also are well-known in the arts, such as, without limitation, an HP-1 heat pipe from Thermacore Inc., Lancaster, Pa., USA. In some embodiments plural heat pipes thermally couple the heat shoe and the heat diffuser, further enhancing heat conduction.

Thus, by coupling a heat pipe 120a, 120b to a heat diffuser 130, a substantial amount of heat may be drawn away from the heated end of the heat tube, as may be the case when thermally coupled to a heat shoe 110 fitted around, and thermally linked to, an FHP motor (Not shown). Materials for a heat shoe and a heat diffuser are ubiquitous and are well-known in the thermal engineering arts, and typically include a metal such as aluminum, copper, or an Al—Cu alloy, although other thermally-conductive metals may be used. A thermally-conductive, electrically insulative thermal interface material, such as mica or one of well-known ceramic-based materials, may be interposed in contacts between the heat shoe and the motor.

FIG. 2 illustrates an example of other embodiments of an active FHP cooled motor 200. Similar to passive motor cooler 100, with heat shoe, thermoconductors 120a, 120b and a heat diffuser 130, active cooled motor 200 includes a fan 250 interposed between the heat shoe 210 and the heat diffuser 230. Motor element 225 may be thermally coupled to the heat shoe by close fit, or by thermal interface materials. Thermoconductors 220a, 220b, such as heat pipes, may be used to conduct heat away from the heat shoe and into the heat diffuser 230. The fan 250 can be oriented with the intake side proximate to the motor 225 and the discharge side proximate to the heat diffuser 230. Alternately, fan 250 can be oriented with the intake side proximate to the heat diffuser 230 and the discharge side proximate to the motor 225. Typically, air flow 222 from fan 250 will be towards heat diffuser 230.

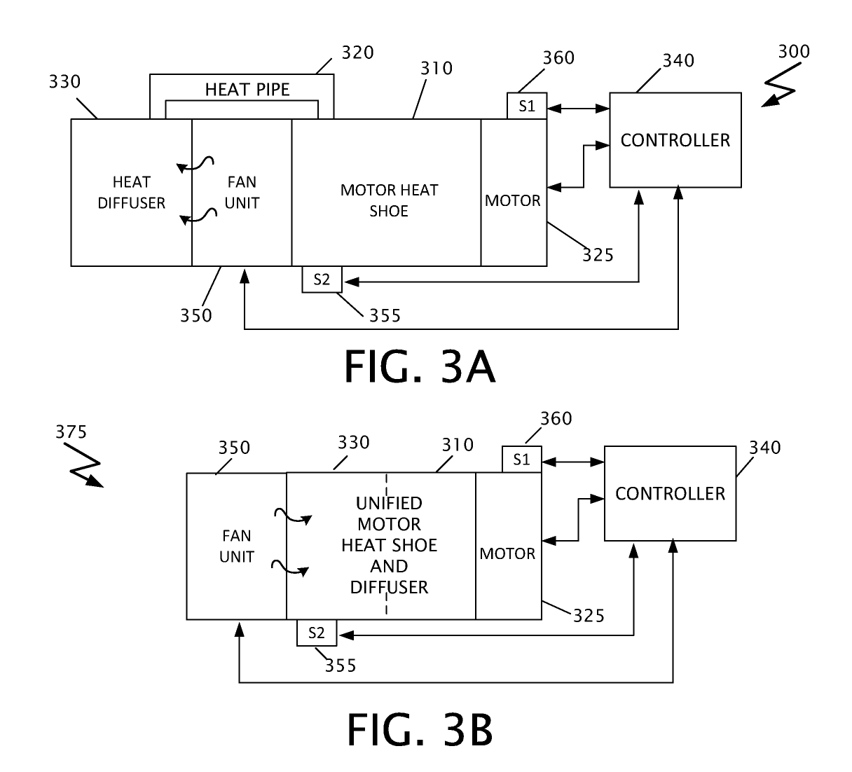

The fan 250 can operate continuously or, as depicted in FIGS. 3A and 3B, fan unit 350 can be controlled be electrically coupled to a controller 340. In FIG. 3A, active cooling motor 300 uses controller 340 to monitors the motor temperature, for example, with sensor S1 350 on the motor 325 casing, or on sensor S2 355 on the heat shoe 310, or at the heat diffuser 330, with the fan speed and, by extension air flow, being varied by the controller 340 in response to a thermal condition of the motor. For example, when the motor element 325 temperature exceeds a predetermined threshold, as detected by the motor sensor 360 and relayed to the controller 340, the controller can increase the speed at which the at least one fan in fan unit 350 spins, forcing more air over the radiative fins of the heat diffuser 330.

Although the controller 340 and fan 350 can be responsive to a thermal condition of the motor element 325, the controller 340 also may increase fan 350 speed in response to a sensed change 390 in a mechanical condition, such as decreased motor speed or an increased motor torque or an ambient condition. FIG. 3A illustrates active cooling with separate heat shoe and heat diffuser linked with heat pipes. On the other hand, FIG. 3B depicts active cooling motor 375 in which heat shoe 310 may be integrated with heat diffuser 330. Heat shoe 310 can be configured to fit on motor element 325. In such a configuration, fan 350 can create convective thermal force to remove heat from diffuser by directing air flow 323 in the direction of diffuser portion 330.

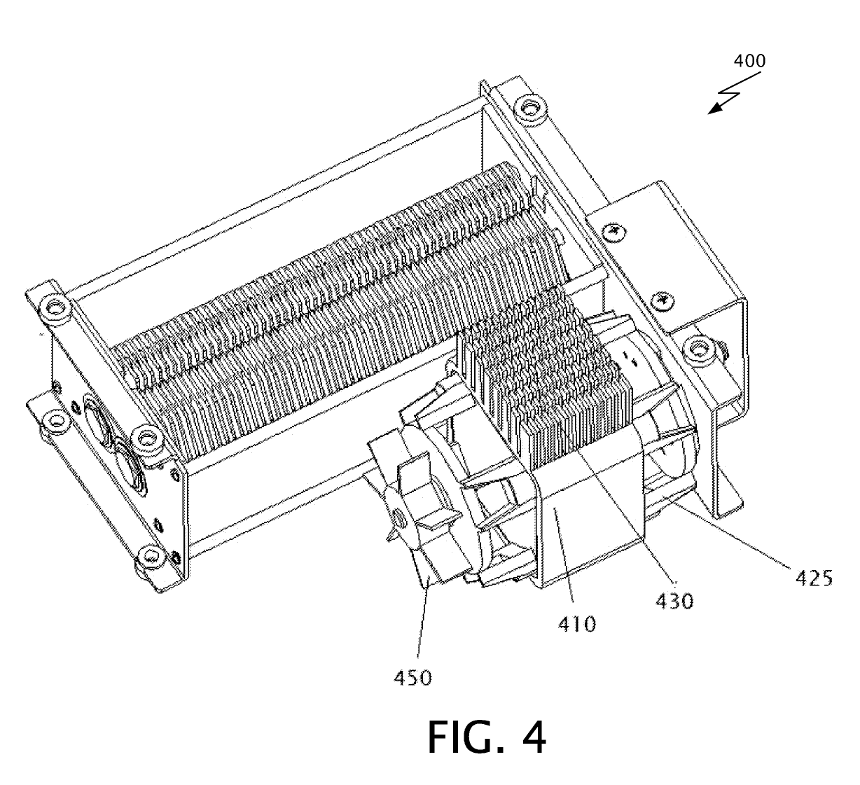

FIG. 4 illustrates yet another example of an active FHP motor 400, which may include a heat shoe 410, a thermoconductor 420, a heat diffuser 430, and fan unit 450, thermically coupled to motor element 425. In this embodiment, thermoconductor 420 can be a thermal interface element including, without limitation, a thermal pad, a thermal grease, a thermal paste, mica, a ceramic-based compounds, or other thermoconductive element interposed between and thermally coupled to heat shoe 410 and heat diffuser 430. Thermoconductor 420 may be thermally conductive but electrically insulative. Motor element 425 and heat shoe 410 may similarly be thermally linked. Alternatively, heat shoe 410 may be integrated with heat diffuser 430 as a unitary piece configured to fit on motor element 425.

Fan unit 450 may be coupled to a controller, such as controller 340 in FIG. 3. Controller 340 may cause the operating speed of fan unit 450 to change responsive to a sensed thermal condition of motor element 425. In general, as the sensed temperature corresponding to motor element 425 increases, the fan speed of fan unit 450 may increase. Controller 340 also may cause the operating speed of fan unit 450 to respond to a mechanical condition of motor element 425. Fan unit 450 may include one or more fan blades to provide thermal convective force. Fan unit 450 may operate to force air over heat diffuser 430. Motor element 425 also may be convectively cooled by fan unit 450.

The embodiments of the present invention disclosed herein are intended to be illustrative only, and are not intended to limit the scope of the invention. It should be understood by those skilled in the art that various modifications and adaptations of the prevent invention as well as alternative embodiments of the prevent invention may be contemplated or foreseeable. It is to be understood that the present invention is not limited to the sole embodiments described above, but encompasses any and all embodiments within the scope of the following claims.

What is claimed is:

1. A cooling apparatus for a motor, comprising:
a heat shoe configured to at least partially cover a portion of and to receive motor thermal energy from a fractional-horsepower motor;
a thermoconductor coupled to the heat shoe, and configured to convey the motor thermal energy from the heat shoe;
a heat diffuser, coupled to receive motor thermal energy from the thermoconductor, and configured to diffuse at least a portion of the motor thermal energy into an ambient air apart from the motor.

2. The cooling apparatus of claim 1, further comprising:
a fan coupled between the motor and the diffuser,
wherein a fan air flow intake is proximate to the motor and a fan air flow outlet is proximate to the heat diffuser,
wherein the fan has at least two blades, and
wherein air is drawn by the fan from the ambient region of the motor and forced to the ambient region of the diffuser, increasing the motor thermal energy removed from the motor.

3. The cooling apparatus of claim 2, further comprising:
a thermal sensor coupled to the motor and configured to sense a motor thermal condition; and
a shredder controller coupled to the thermal sensor and to the fan,
wherein the shredder controller is configured to control the speed of the fan relative to the motor thermal condition.

4. The cooling apparatus of claim 3, wherein the shredder controller is configured to control the speed of the fan relative to a motor condition other than the motor thermal condition.

5. The cooling apparatus of claim 1, further comprising an AC motor.

6. The cooling apparatus of claim 1, further comprising a DC motor.

7. The cooling apparatus of claim 1, further comprising a brushed electric motor.

8. The cooling apparatus of claim 1, further comprising a brushless electric motor.

9. A cooling apparatus for a shredder motor, comprising:
a heat shoe configured to be in thermal contact with the motor; and
a heat diffuser integrated with the heat shoe.

10. A cooling apparatus for a motor, comprising:
a heat shoe configured to at least partially cover a portion of and to receive motor thermal energy from a fractional horsepower motor;
a heat pipe coupled to the heat shoe, and configured to convey the motor thermal energy from the heat shoe;
a heat diffuser, coupled to receive motor thermal energy from the heat pipe, and configured to diffusingly release at least a portion of the motor thermal energy into an ambient atmosphere apart from the motor;
a fan having at least two fan blades coupled between the motor and the heat diffuser;
a thermal sensor coupled to one of the motor or the heat shoe and configured to sense a motor thermal condition; and
a controller coupled to the thermal sensor and to the fan,
wherein the controller is configured to control the speed of the fan relative to the motor thermal condition or to a motor mechanical condition,
wherein a fan air flow intake is proximate to the motor and a fan air flow outlet is proximate to the heat diffuser, and
wherein air is drawn by the fan from the ambient region of the motor and forced to the ambient region of the diffuser, increasing the motor thermal energy removed from the motor.

11. The cooling apparatus of claim 5, further comprising an AC motor.

12. The cooling apparatus of claim 5, further comprising a DC motor.

13. The cooling apparatus of claim 5, further comprising a stepper motor.

14. The cooling apparatus of claim 5, further comprising a brushed electric motor.

15. The cooling apparatus of claim 5, further comprising a brushless electric motor.

16. A method for cooling a motor, comprising:
conductively receiving motor thermal energy from portion of a fractional-horsepower motor by a heat shoe;
conductively receiving motor thermal energy by a thermoconductor coupled to the heat shoe;
conveying motor thermal energy by the heat pipe to a heat diffuser;
receiving motor thermal energy by the heat diffuser from the thermoconductor;
releasing the motor thermal energy from the heat diffuser causing the motor to be cooled.

17. The method of claim 16, wherein the thermoconductor comprises a heat pipe containing a convective fluid, and wherein conveying motor thermal energy away from the motor comprises convecting motor thermal energy to the heat diffuser.

18. The method of claim 16, wherein the heat pipe comprises a thermoconductive material and wherein conveying motor thermal energy comprises conducting motor thermal energy to the heat diffuser.

19. The cooling apparatus of claim 16, further comprising a brushed electric motor.

20. The cooling apparatus of claim 16, further comprising a brushless electric motor.
